(19) United States
(12) Patent Application Publication
(10) Pub. No.: US 2019/0368018 A1
(43) Pub. Date: Dec. 5, 2019

(54) IRON-BASED AMORPHOUS ALLOY

(71) Applicant: QINGDAO YUNLU ADVANCED MATERIALS TECHNOLOGY CO., LTD., Qingdao, Shandong (CN)

(72) Inventors: Hongyu LIU, Qingdao, Shandong (CN); Dong YANG, Qingdao, Shandong (CN); Qinghua LI, Qingdao, Shandong (CN); Jing PANG, Qingdao, Shandong (CN)

(73) Assignee: Qingdao Yunlu Advanced Materials Technology Co., Ltd., Qingdao, Shandong (CN)

(21) Appl. No.: 16/477,191

(22) PCT Filed: Oct. 31, 2017
(86) PCT No.: PCT/CN2017/108475

§ 371 Date: Jul. 11, 2019

(30) Foreign Application Priority Data
Jul. 31, 2017 (CN) 201710637409.8

(51) Int. Cl. C22C 45/02; C22C 38/02; C21D 1/04; C21D 1/76; H01F 1/153; H01F 27/25

(52) U.S. Cl. CPC C22C 45/02; C22C 38/02; C21D 1/04; C22C 2200/02; H01F 1/15308; H01F 27/25; C21D 1/76

(57) ABSTRACT

An iron-based amorphous alloy, i.e., FeₐSi_{b}B_{c}P_{d}, wherein a, b, c, and d respectively represent the atom percentages of corresponding components; 81.0≤a≤84.0, 1.0≤b≤6.0, 9.0≤c≤14.0, 0.05≤d≤3, and a+b+c+d=100. By adjusting the components and component percentages of the iron-based amorphous alloy, the obtained iron-based amorphous alloy has high saturation magnetic induction density.

### CROSS REFERENCE TO RELATED APPLICATIONS

This application claims the priority of Chinese Patent Application No. 201710637409.8, filed on Jul. 31, 2017, and titled with “IRON-BASED AMORPHOUS ALLOY”, and the disclosures of which are hereby incorporated by reference.

### FIELD

The present disclosure relates to the field of iron-based amorphous alloy technology, specifically to an iron-based amorphous alloy.

### BACKGROUND

Iron-based amorphous strip is a new type of energy-saving material, which is generally prepared by rapid rapid-cooling solidification production process. Compared with traditional silicon steel transformers, if the iron-based amorphous strip is used as an iron core of the transformer, the magnetization process is quite easy, so as to dramatically decrease the no-load loss of the transformer; if it is used in an oil-immersed transformer, it can also reduce the emission of harmful gases such as CO, SO, NOₓ, and thus it is called “green material” in the 21^{st} century.

At present, in the process of preparing amorphous transformers at home and abroad, iron-based amorphous strip with a saturation magnetic induction density of about 1.56 T is widely used. Compared with silicon steel with a saturation magnetic induction density of nearly 2.0 T, the iron-based amorphous strip has a disadvantage of large volume in the preparation of transformers. In order to improve competitive power of the iron-based amorphous material in transformer manufacturing industry, it is necessary to develop an iron-based amorphous material with a saturation magnetic induction density of above 1.6 T.

The development of amorphous materials with high saturation magnetic induction density has been carried out for many years. The most representative one is an alloy named Metglas2605Co developed by Allied-Signal in America. The alloy has a saturation magnetic induction density of 1.8 T, but the alloy contains 18% of Co element, giving the alloy an extremely high cost, so that it cannot be used in industry production.

In a Chinese patent application with a publication No. CN1721563A, Hitachi Metals. Ltd. discloses a Fe—Si—B—C alloy, which has a saturation magnetic induction density of 1.64 T. However, in its disclosed process conditions, a process comprising blowing C-contained gases to control the distribution of the C element content on the surface of the strip is mentioned, which process would make it difficult to control the process conditions during product production, and hard to ensure the stability of the industrial production. Nippon Steel discloses a Fe—Si—B—P—C alloy in patent No. CN1356403A. Although its saturation magnetic induction density is 1.75 T, its amorphous forming ability is poor due to its unduly high Fe content, making it impossible to form into an amorphous state in industrial production, and leading to poor magnetic properties of the strip.

In a Chinese patent application with a publication No. CN101840764A, Ningbo Institute of Industrial Technology of CAS discloses a Fe—Si—B—P—C alloy. However, in the patent, laboratory raw materials are used for preparing amorphous strips, which have the following problems in the industrial process: adding C element in the alloy system, although the addition of C can improve the amorphous forming ability, in the industrial process, C element is mainly introduced through two ways: one is to use pig iron and the other is to use graphite, but the two raw materials are not suitable for the smelting process of amorphous strip; unduly high content of impurities in pig iron may lead to crystallization of the strip during the preparation process, thereby effecting the magnetic properties; and the melting point of graphite is unduly high, if graphite is used in the smelting process at present, it is necessary to optimize or increase the smelting process, making industrial production more difficult.

Based on the above problems, the present disclosure starts from the optimization design of the alloy composition and the optimization of the heat treatment process, and uses a FeSiBP quaternary alloy system to invent an iron-based amorphous alloy strip suitable for industrial production with high saturation magnetic induction density and low loss.

### SUMMARY

The technical problem to be solved by the present disclosure is to provide an iron-based amorphous alloy with high saturation magnetic induction density.

In view of this, the present disclosure provides an iron-based amorphous alloy as shown in formula (I),

FeₐSi_{b}B_{c}P_{d}
wherein, a, b, c and d respectively represent an atomic percent of the corresponding component; 81.0≤a≤84.0, 1.0≤b≤6.0, 9.0≤c≤14.0, 0.05≤d≤3, and a+b+c+d=100.

Preferably, the atomic percent of B is 11.0≤c≤13.0.

Preferably, the atomic percent of P is 1≤d≤3.

Preferably, in the iron-based amorphous alloy, 83.0≤a≤84.0, 3.0≤b≤6.0, 9.0≤c≤13.0, and 1≤d≤3.

Preferably, in the iron-based amorphous alloy, 81.5≤a≤82.5, b=3.0, 12.5≤c≤14.0, and 1≤d≤3.

Preferably, the saturation magnetic induction density of the iron-based amorphous alloy is ≥1.62 T.

Preferably, the heat treatment process of the iron-based amorphous alloy is carried out under an atmosphere of H₂ in a holding temperature of 300 to 360° C. and a magnetic field intensity of 800 to 1400 A/m for 60 to 120 minutes.

Preferably, after the heat treatment, the iron-based amorphous alloy has a coercive force of ≤4 A/m, an iron core loss of ≤0.18 W/kg, and an exciting power of ≤0.22 VA/kg.

Preferably, after the heat treatment, the iron-based amorphous alloy has a width of 100 to 200 mm, and a thickness of 23 to 28 μm.

The present disclosure also provides use of the iron-based amorphous alloy in the iron core of an electric distribution transformer.

The present disclosure also provides an iron-based amorphous alloy as shown in formula FeₐSi_{b}B_{c}P_{d}, wherein, a, b, c and d respectively represent an atomic percent of the corresponding component; 81.0≤a≤84.0, 1.0≤b≤6.0, 9.0≤c≤14.0, 0.05≤d≤3, and a+b+c+d=100. In the iron-based amorphous alloy provided in the present disclosure, Fe element, as a ferromagnetic element, is the main magnetism source of the iron-based amorphous alloy, and high content of Fe is an important guarantee of high saturation magnetic induction density of the iron-based amorphous alloy strip; Si and B, as amorphous forming elements, are necessary conditions for forming an amorphous alloy; P is also an amorphous forming element, and P and Fe have a relatively large negative heat of mixing between P and Fe, which is advantageous for improving the stability of the supercooled liquid phase of the alloy system, but impurities are introduced. Therefore, by adding the above elements and controlling the contents of them, the present disclosure results in an iron-based amorphous alloy with relatively high saturation magnetic induction density. Further, through a magnetic field heat treatment under a hydrogen atmosphere, the present disclosure eliminates the magnetic stress of the iron-based amorphous alloy, reduces the coercive force, improves the magnetic conductivity, and finally obtains an iron-based amorphous alloy with excellent magnetic properties.

### BRIEF DESCRIPTION OF DRAWINGS

FIG. 1 shows an XRD pattern of as-deposited states of the examples and the comparative examples in the present disclosure.

FIG. 2 shows the surface oxidation after heat treatment of the examples and the comparative examples in the present disclosure.

FIG. 3 shows diagrams of relationships between the magnetic properties and the heat treatment temperatures of the examples and the comparative examples in the present disclosure.

FIG. 4 shows a comparative diagram of the loss curves of the examples and the comparative examples under condition of 50 Hz in the present disclosure.

### DETAILED DESCRIPTION

For further understanding the present disclosure, preferred embodiments of the present disclosure will be described with reference to the examples hereinafter. However, it should be noted that these descriptions are merely a further illustrating of the characters and advantages of the present disclosure, but not limitations of the claims of the present disclosure.

In order to obtain an iron-based amorphous alloy with high saturation magnetic induction density, by selecting the above elements and controlling the contents of them, the present disclosure obtains an iron-based amorphous alloy. Specifically, the iron-based amorphous alloy is as shown in formula (I),

FeₐSi_{b}B_{c}P_{d} (I);
wherein, a, b, c and d respectively represent an atomic percent of the corresponding component; 81.0≤a≤84.0, 1.0≤b≤6.0, 9.0≤c≤14.0, 0.05≤d≤3, and a+b+c+d=100.

The present disclosure provides a FeSiBP quaternary system iron-based amorphous alloy with high saturation magnetic induction density and low loss. Further, through using a hydrogen atmosphere in the heat treatment process, the oxidation of the strip is improved and the magnetic property of the strip is increased.

Specifically, in the above iron-based amorphous alloy, Fe element, as a ferromagnetic element, is the main magnetism source of the iron-based amorphous alloy, and high content of Fe is an important guarantee of high saturation magnetic induction density of the iron-based amorphous alloy strip; but unduly high content of Fe element may lead to decrease of the amorphous forming ability of the alloy, making it hard to realize an industrial production. In the present disclosure, the atomic percent of Fe is 81.0≤a≤84.0. In a specific embodiment, the atomic percent of Fe is 81.5 to 83. More specifically, the atomic percent of Fe is 81.5, 82, 82.5, 83, 83.5 or 84.

The Si and B elements are amorphous forming elements, which are necessary conditions for an alloy system to the form an amorphous state in the industrial production condition. The atomic percent of Si element is 1.0 to 6.0. Unduly low content of Si may lead to decrease of amorphous forming ability, and affect the magnetic properties of the strip. Unduly high content of Si also lead to deviation of eutectic point, and the amorphous forming ability is also reduced. In specific embodiments, the content of Si is 2.0 to 6.0. Specifically, the content of Si is 2.0, 3.0, 4.0, 5.0 or 6.0. The range of B element is 9.0 to 14.0. If it is less than 9, the amorphous forming ability of the alloy is low. If it is more than 14.0, the eutectic point is deviated and the amorphous forming ability of the alloy is decreased. In specific embodiments, the content of B is 11.0 to 13.0.

P element, like Si and B elements, is also an amorphous forming element, and P and Fe have a relatively large negative heat of mixing. The addition of P is beneficial to improve the stability of the supercooled liquid phase of the alloy system, and function as an amorphous forming element. However, in the actual industrial production process, the addition of P is mainly realized by ferrophosphorus. A large addition amount of the ferrophosphorus would introduce a large amount of impurities into the liquid steel, seriously decreasing the quality of the liquid steel. On the one hand, they will affect the success rate of the preparation of the strip, making it hard for the strip to form an amorphous state; on the other hand, they will affect the magnetic properties of the strip, and large amounts of the impurities are solidified in the strip, which would form internal defects and mass points inside the strip, and would have a pinning effect on magnetic domain in heat treatment process, leading to deterioration of the magnetic properties of the strip. If the addition content of P is less than 0.05, the P element exists in a form of trace element in the whole alloy system, which cannot improve the supercooled liquid phase of the alloy system, nor can it improve the magnetic properties of the iron-based amorphous strip. Therefore, in the present disclosure, the range of P element is 0.05 to 3, which on the one hand controls the introduction of impurities, and on the other can enhance the amorphous forming ability of the whole alloy system. In some embodiments, the content of P is 1 to 3. More specifically, the content of P is 1.0, 2.0 or 3.0. In the iron-based amorphous alloy of the present disclosure, impurity is inescapable.

In some specific embodiments, the content of each component in the iron-based amorphous alloy is: 83.0≤a≤84.0, 3.0≤b≤6.0, 9.0≤c≤13.0, and 1≤d≤3; in some specific embodiments, the content of each component in the iron-based amorphous alloy is: 81.5≤a≤82.5, b=3.0, 12.5≤c≤14.0, and 1≤d≤3. The iron-based amorphous alloys with an above component content have better magnetic properties.

In the present disclosure, the iron-based amorphous alloy is prepared by a method well-known to those skilled in the art, and the detailed processes are not specifically repeated herein. Moreover, in the heat treatment stage of the present disclosure, the conditions of the heat treatment process are: a protective atmosphere of H₂, a holding temperature of 320 to 380° C., a holding time of 60 to 120 min, and a magnetic field intensity of 800 to 1400 A/m.

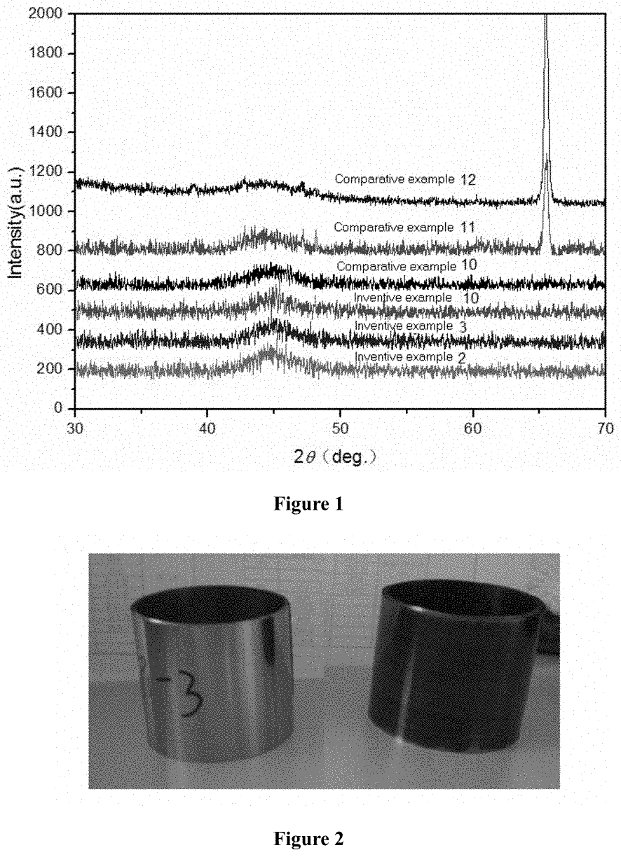

Except for the alloy composition itself, heat treatment process is also a critical factor that influences the magnetic properties of the amorphous and nanocrystalline soft magnetic materials. By annealing treatment, the stress of the amorphous magnetic material is eliminated, the coercive force is reduced, the magnetic conductivity is increased, and excellent magnetic properties are obtained. For the present disclosure, if the heat treatment is carried out under a common atmosphere condition, the surface of the strip will be oxidized and thus the magnetic properties will be deteriorated. Thus, the heat treatment of the present disclosure is carried out in a pure hydrogen atmosphere, as shown in the comparison of FIG. 1. It can be concluded from results of tremendous amount of experiments that surface of the iron-based amorphous alloy strip after the above heat treatment process is not oxidized, and the magnetic properties are excellent. For iron-based amorphous strip, except for atmosphere condition, the heat treatment process further includes three parameters: holding temperature, holding time and magnetic field intensity. Firstly, the holding temperature must be lower than the crystallization temperature. Once the holding temperature is higher than the crystallization temperature, the amorphous stripe will be crystallized, and the magnetic properties will be deteriorated rapidly. In the present disclosure, the crystallization temperatures of the alloys are all lower than 500° C. Under the circumstance that the holding temperature is lower than the crystallization temperature, a suitable holding temperature range is a guarantee for the amorphous strip to obtain excellent magnetic properties. It can be concluded from the results of the examples in the present disclosure that the relationship between the iron core loss, the exciting power and the holding temperature is: with the increase of the holding temperature, the two parameters have a trend of first decreasing and then increasing. Therefore, in the present disclosure, if the holding temperature is less than 300° C. or larger than 360° C., the properties will deteriorate, and eligible magnetic properties are obtained in 300 to 360° C. Secondly, for the holding time, it complies with the same principle as that of the holding temperature. It has a suitable time range. Optimum properties cannot be achieved if the holding time is unduly short or unduly long. Finally, suitable magnetic field intensity is a necessary guarantee for the magnetization of the material. The main reason for carrying out magnetic field annealing on amorphous material is that magnetic field with a fixed direction and a fixed intensity facilitates magnetic domain of the material turns to the direction of magnetic field, reducing the magnetic anisotropy of the material, and optimizing the soft magnetic properties. In the present disclosure, if the magnetic field intensity is less than 800 A/m, the magnetization process of the material is not completed, failing to achieve an optimal effect. If the magnetic field intensity is >1400 A/m, the magnetization process of the material is completed. Magnetic properties will not be optimized as the increase of the magnetic field intensity, and difficulty and cost of the heat treatment process are increased.

Therefore, after heat treatment, the iron-based amorphous alloy in the present application has an iron core loss of P≤0.1800 W/kg, and an exciting power of Pe≤0.2200 VA/kg, and a coercive force of Hc≤4 A/m. Coercive force is an important index to evaluate the property of soft magnetic materials. The smaller coercive force is, the better the soft magnetic property will be. For amorphous strip used in distribution transformer industry, the indexes used to evaluate the magnetic property mainly are the two indexes: iron core loss and exciting power. The smaller the two indexes are, the better the property of the follow-up iron core and transformer will be.

For further understanding the present disclosure, the iron-based amorphous alloy strips provided in the present disclosure will be described in details with reference to the embodiments hereinafter. The scope of protection of the present disclosure is not limited to the embodiments herein.

### Example

in the present disclosure, ingredients were prepared in proportion to the alloy composition FeₐSi_{b}B_{c}P_{d}M_{f} and the metal raw materials were remelted in a medium frequency smelting furnace, wherein the smelting temperature was 1300 to 1500° C. and the time was 80 to 120 min. After the smelting, the melting liquid was heated, heat insulated, and subjected to single roll rapid quenching to obtain an iron-based amorphous wide strip with a width of 142 mm and a thickness of 23 to 28 μm, wherein the temperature was heated to 1350 to 1470° C. and the holding time is 20 to 50 min. Table 1 showed data of alloy composition, saturation magnetic induction density, and excitation powder and iron core loss under the condition of 1.35 T/50 Hz in the examples of the present disclosure and the comparative examples, among which the inventive examples 1 to 10 were the examples of the present disclosure and the comparative examples 11 to 15 were for comparison.

TABLE 1
Data of the components and properties in the inventive
examples and the comparative examples

| | | | | | | | | | Heat Treatment Process ^{b} | | | |
|---|---|---|---|---|---|---|---|---|---|---|---|---|
| | | | | | | | Magnetic Properties ^{a} | | Holding | | | |
| | Element | | | | | Crystallized | | P/ | Temperature/ | Holding | | Oxidized |
| Number | Fe | Si | B | P | Bs/(T) | or Not | Pe/(VA/kg) | (W/kg) | ° C. | Time/min | Atmosphere | or Not |
| Inventive | 83 | 2 | 14 | 1 | 1.65 | No | 0.165 | 0.142 | 320-340 | 60-100 | H₂ | No |
| Example 1 | | | | | | | | | | | | |
| Inventive | 83 | 3 | 13 | 1 | 1.66 | No | 0.158 | 0.138 | 330-350 | 60-100 | H₂ | No |
| Example 2 | | | | | | | | | | | | |
| Inventive | 83 | 3 | 11 | 3 | 1.66 | No | 0.188 | 0.154 | 330-350 | 60-100 | H₂ | No |
| Example 3 | | | | | | | | | | | | |
| Inventive | 83 | 3 | 12 | 2 | 1.65 | No | 0.176 | 0.159 | 330-350 | 60-100 | H₂ | No |
| Example 4 | | | | | | | | | | | | |
| Inventive | 83 | 4 | 12 | 1 | 1.65 | No | 0.155 | 0.134 | 325-345 | 60-100 | H₂ | No |
| Example 5 | | | | | | | | | | | | |
| Inventive | 83 | 5 | 11 | 1 | 1.64 | No | 0.166 | 0.147 | 330-350 | 60-100 | H₂ | No |
| Example 6 | | | | | | | | | | | | |
| Inventive | 83 | 6 | 9 | 2 | 1.65 | No | 0.172 | 0.149 | 340-360 | 60-100 | H₂ | No |
| Example 7 | | | | | | | | | | | | |
| Inventive | 81.5 | 3 | 14 | 1.5 | 1.62 | No | 0.155 | 0.136 | 330-350 | 60-100 | H₂ | No |
| Example 8 | | | | | | | | | | | | |
| Inventive | 82.5 | 3 | 13.5 | 1 | 1.63 | No | 0.162 | 0.14 | 330-350 | 60-100 | H₂ | No |
| Example 9 | | | | | | | | | | | | |
| Inventive | 84 | 3 | 12 | 1 | 1.66 | No | 0.174 | 0.153 | 330-350 | 60-100 | H₂ | No |
| Example 10 | | | | | | | | | | | | |
| Comparative | 83 | 3 | 9 | 5 | 1.63 | Yes | 2.567 | 0.158 | 350-370 | 60-100 | H₂ | Yes |
| Example 11 | | | | | | | | | | | | |
| Comparative | 85 | 3 | 11 | 1 | 1.6 | Yes | 1.569 | 0.656 | 310-330 | 60-100 | H₂ | No |
| Example 12 | | | | | | | | | | | | |
| Comparative | 78 | 9 | 13 | | 1.56 | No | 0.156 | 0.138 | 360-380 | 60-100 | Ar | No |
| Example 13 | | | | | | | | | | | | |
| Comparative | 83 | 3 | 13 | 1 | 1.66 | No | 2.389 | 0.189 | 330-350 | 60-100 | Ar | Yes |
| Example 14 | | | | | | | | | | | | |
| Comparative | 83 | 3 | 11 | 3 | 1.66 | No | 3.257 | 0.174 | 330-350 | 60-100 | Ar | Yes |
| Example 15 | | | | | | | | | | | | |

Comments:
^{a}The magnetic properties shown in Table 1 were the magnetic property of each example obtained at the optimum holding temperature and the optimum holding time.
^{b}The heat treatment range shown in Table 1 were temperature ranges and time ranges in which stable magnetic properties could be obtained in each example, i.e., the fluctuation of Pe and P was within the range of the optimum performance value ± 0.01.

It can be concluded from Table 1 that alloy composition conforming to the examples of the present disclosure all have relatively good saturation magnetic induction density, which is not less than 1.62 T, higher than the conventional iron-based amorphous material commonly used in the power transformer at present, which has a saturation magnetic induction density of 1.56 T (comparative example 13). Improvement of the saturation magnetic induction density can further optimize the iron core design of the transformer, reducing volume of the transformer and decreasing the cost. It can also be concluded that alloy composition conforming to the examples of the present disclosure can each prepare entirely amorphous strips, and the alloy composition conforming to the examples of the present disclosure have relatively good magnetic properties. Under conditions of 50 Hz and 1.35 T, the heat treated iron core has an exciting power of ≤0.2200 VA/kg and an iron core loss of ≤0.1800 W/kg, which meet the operational requirements as compared with the conventional amorphous material (comparative example 13).

It can be concluded from Table 1 and FIG. 1 (inventive examples 1 to 10 and comparative Example 11) that alloy composition with excessive amount of P will lead to crystallization phenomenon of the strip, mainly due to unduly high content of impurity in the industrially prepared ferrophosphorus. If the addition of P element is >3, excessive amount of impurities will be brought in, so that an entirely amorphous stripe could not be obtained in actual industrial production. It can be concluded from inventive examples 1 to 10 and comparative Example 12 that if Fe content is unduly high, the amorphous forming ability of the alloy will be relatively poor, and the strip may be crystallized.

It can be seen from Table 1 and FIG. 2 (comparison of inventive examples 1 to 10 and comparative Example 13, comparative examples 14 and 15; in FIG. 2, the left figure is iron-based amorphous alloys treated with hydrogen atmosphere, and the right figure is iron-based alloys treated with argon atmosphere) that, in the present disclosure, oxidation phenomenon would not occur after a heat treatment only if treated with hydrogen atmosphere. In comparative examples 14 and 15, in which they were treated with pure argon, the surface was oxidized (becoming blue), and the magnetic properties were seriously deteriorated.

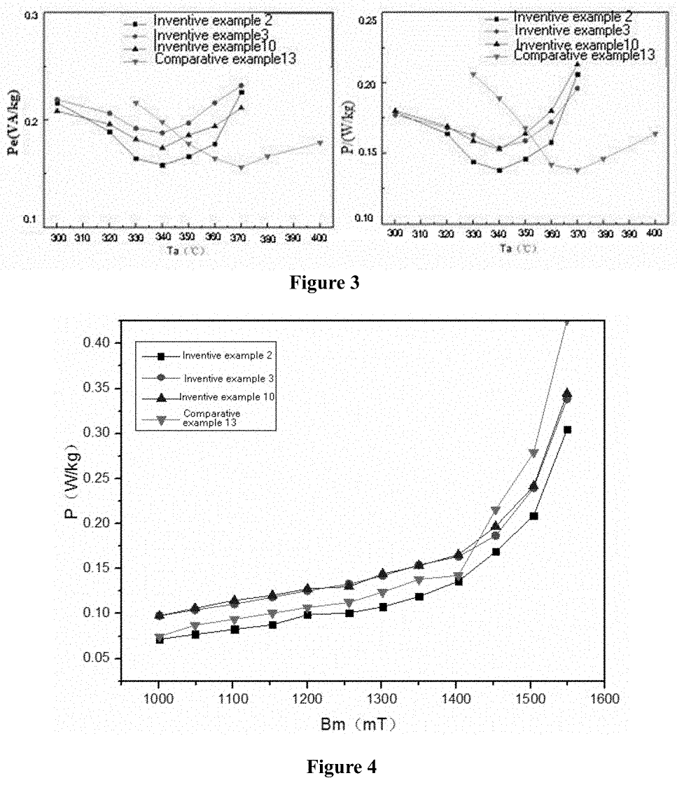

FIG. 3 shows that all the alloys of the present disclosure have stable magnetic properties in a relatively wide temperature range (at least 20° C.), i.e., the fluctuation of Pe and P is within the range of ±0.01. Compared with conventional 1.56 T amorphous strip materials, the optimum heat treatment temperature is at least lowered by 20° C., which can reduce the temperature control requirements of the heat treatment equipment, increase the service life of the heat treatment equipment, and indirectly reduce the cost of the heat treatment process.

FIG. 4 illustrates that the alloy of the present disclosure has a superior performance over the conventional iron-based amorphous material under higher working magnetic density conditions; that is, the iron core and transformer prepared from the iron-based amorphous material made of the alloy composition of the present disclosure can be operated under higher working magnetic density conditions.

The above descriptions of the embodiments are merely to assist in understanding the method of the present disclosure and its core idea. It should be noted that those skilled in the art can make various improvements and modifications to the present disclosure without departing from the principles of the present disclosure, and those improvements and modifications fall into the protection scope of the present disclosure.

The above descriptions of the disclosed embodiments enable those skilled in the art to realize or use the present disclosure. Various modifications to these embodiments are obvious to those skilled in the art, and the general principles defined herein may be implemented in other embodiments without departing from the spirit or scope of the present disclosure. Therefore, the present disclosure is not to be limited to the embodiments shown herein, but complies with the widest scope consistent with the principle and novel features disclosed herein.

1. An iron-based amorphous alloy as shown in formula (I),
FeₐSi_{b}B_{c}P_{d} (I);
wherein, a, b, c and d respectively represent an atomic percent of corresponding component; 81.0≤a≤84.0, 1.0≤b≤6.0, 9.0≤c≤14.0, 0.05≤d≤3, and a+b+c+d=100.

2. The iron-based amorphous alloy according to claim 1, wherein atomic percent of B is 11.0≤c≤13.0.

3. The iron-based amorphous alloy according to claim 1, wherein atomic percent of P is 1≤d≤3.

4. The iron-based amorphous alloy according to claim 1, wherein in the iron-based amorphous alloy, 83.0≤a≤84.0, 3.0≤b≤6.0, 9.0≤c≤13.0, and 1≤d≤3.

5. The iron-based amorphous alloy according to claim 1, wherein in the iron-based amorphous alloy, 81.5≤a≤82.5, b=3.0, 12.5≤c≤14.0, and 1≤d≤3.

6. The iron-based amorphous alloy according to claim 1, wherein saturation magnetic induction density of the iron-based amorphous alloy is ≥1.62 T.

7. The iron-based amorphous alloy according to claim 1, wherein heat treatment process of the iron-based amorphous alloy is carried out under an atmosphere of H₂ at a holding temperature of 300 to 360° C. with a magnetic field intensity of 800 to 1400 A/m for 60 to 120 minutes.

8. The iron-based amorphous alloy according to claim 7, wherein after the heat treatment, the iron-based amorphous alloy has a coercive force of ≤4 A/m, an iron core loss of ≤0.18 W/kg, and an exciting power of ≤0.22 VA/kg.

9. The iron-based amorphous alloy according to claim 7, wherein after the heat treatment, the iron-based amorphous alloy has a width of 100 to 200 mm, and a thickness of 23 to 28 μm.

10. A method for preparing iron core of an electric distribution transformer, comprising using the iron-based amorphous alloy according to claim 1.
